(19) United States
(12) Patent Application Publication
(10) Pub. No.: US 2006/0001665 A1
(43) Pub. Date: Jan. 5, 2006

(54) Color search engine

(76) Inventor: Carl A. Kupersmit, Lake Worth, FL (US)

Correspondence Address: AKERMAN SENTERFITT, P.O. BOX 3188, WEST PALM BEACH, FL, 33402-3188, US

(21) Appl. No.: 11/061,381

(22) Filed: Feb. 17, 2005

Related U.S. Application Data
(63) Continuation of application No. 10/465,080, filed on Jun. 19, 2003.
Application No. 10/465,080 is a continuation of application No. 09/702,103, filed on Oct. 30, 2000, now abandoned.
(60) Provisional application No. 60/196,426, filed on Apr. 12, 2000.

(51) Int. Cl. G06T 15/50

(52) U.S. Cl. 345/426

(57) ABSTRACT

A computerized color matching method can include receiving at least one color space matching parameter for matching a first color to a second color. The first color can correspond to color specification parameters defined in a color characterization system. Second, based upon the color specification parameters of the first color and the color space matching parameter, new color specification parameters can be computed. The new color specification parameters can correspond to said second color. As such, the second color can match the first color. The computing step can also include computing new color specification parameters based upon the color specification parameters of the first color, the color space matching parameter, and a randomly generated value.

### CROSS REFERENCE TO RELATED APPLICATIONS

This application is a continuation of U.S. patent application Ser. No. 10/465,080, filed Jun. 19, 2003, currently, which is a continuation of U.S. patent application Ser. No. 09/702,103, filed on Oct. 30, 2000, now abandoned, which claims the benefit of U.S. Provisional Application No. 60/196,426, filed Apr. 12, 2000.

### STATEMENT REGARDING FEDERALLY SPONSORED RESEARCH OR DEVELOPMENT

(Not Applicable)

### BACKGROUND OF THE INVENTION

1. Technical Field

This invention relates to the field of computer data search programs and more particularly to a system and method for searching and producing matching color information.

2. Description of the Related Art

Generally, e-commerce Internet sites that offer products for sale and provide content related to such products also furnish search capabilities for locating these products. On-line searching enables potential customers to quickly locate products or informational material of interest. The great majority of e-commerce related searching technology is based upon text matching technology. Although some of the text matching technology can be quite sophisticated and can make contextual decisions, extract semantics and even make matches based on like-sounding words, present on-line searching techniques can be ineffective with regard to certain applications, for example color matching and color searching.

Color generally can be characterized using color characterization schemes based upon three or more parameters. These parameters characterize the “color space” as defined by the particular color system being used. For artists and craftsman, some of the most intuitive systems are HSB and HLS. HSB and HLS systems separate color into a hue parameter (H), which basically defines the frequency of the color in the rainbow, a saturation parameter (S), that defines the purity of the color, and a brightness parameter (B, V or L) that accounts for the total amount of light radiated from the color. These systems are more visually intuitive, and can therefore be used to provide the aforementioned capability of finding matching colors—that is, colors that “look well” together. More particularly, matching colors have been defined as combinations of colors which associate well aesthetically.

Color categorization products such as the Pantone System provide a good means of specifying colors and providing color consistency in a manufacturing process, but offer little help with regard to on-line color searching for an Internet user that does not possess Pantone color chips to identify the color being searched. Additionally, existing color searching systems do not provide an interactive means of converging on a desired color, thus forcing the user to examine a large number of color samples one by one in order to find the wanted choice.

There is a need then for color matching and searching capabilities for Internet Web sites that market products that have color as a primary characteristic. Exemplary Web sites can include Web sites which market paints, fabrics, ceramic or other colored tiles, yarn, colored clay or other basic materials as are used in arts-and-crafts. Examples of the latter are beads, thread, and semi-precious stones. Uses for this capability span many markets such as apparel, interior design and decor, accessories that need to be color-matched, jewelry, furniture and architectural design. Significantly, to date, each of the above-identified Web sites have failed to incorporate adequate color searching technology.

### SUMMARY OF THE INVENTION

The present invention is a system and method that provides color search and matching capabilities based on color rather than text. The present invention includes a method used with a computer to find colors that comprise a harmonious combination of colors in accordance with a configurable set of color matching preferences, and a method used with a computer to find items that possess color characteristics that closely match a user-selected color. The methods can be used not only in the context of a stand-alone computer, but also in the context of a networked computer as well as a computer having a connection to the Internet. Both the method and the system of the present invention can be of great value to people who work in arts and crafts and need to combine elements of different colors to create a finished work. Examples of such activities are beading, quilting, painting, weaving, and knitting.

In one aspect of the present invention, the color search method can be configured for operation in a computer connected to the Internet. In particular, a client Web browser in a computer connected to the Internet can access a Web page containing a user interface to the color search method of the present invention. When the Web page has been retrieved, the color search method contained therein in the form of a script can execute in the client Web browser. Alternatively, the color search method can be a server-side program which can be remotely activated through the client Web browser. Finally, the color search method can be distributed across the Internet and can be included as part of programs both executing in a server and in the client Web browser.

Upon execution of the color search method, the user can be presented with a set of menu entries to accomplish a variety of tasks as follows:
(a) Create a color swatch, such color swatch being a bounded area on the computer screen wherein the color can be altered by the user through the use of color controls in another area of the computer screen.
(b) Save a set of color swatches, such color swatches being those that were created using the menu option described in (a) above. This menu allows the user to save the color combinations that were created.
(c) Retrieve a set of color swatches, such color swatches being those that were previously saved using the menu option descried in (b) above.
(d) Delete color swatches displayed on the screen.
(e) Find a predefined color match. This activity presents the user with a choice of predefined color sets containing colors that harmonize well together. Upon making a selection, the system displays color swatches that contain the colors in the selected set. The user can then alter the selections, delete or add color swatches. The user can also then search for products having color characteristics closely matching those of a selected color swatch as described below.
(f) Find a user-directed color match. This activity allows a user to find a color or set of colors that combine well with the color in a color swatch already present on the screen. In order to accomplish this task, the user must select an existing color swatch. The user is then presented with a set of three choices that characterize the type of color contrast desired between the selected color and the resulting one.

A first choice allows the user to select a measure of the contrast desired between the hues of the selected color and that of the resulting color. The hue contrast may be defined using the HSB color model, where the hue of a color is represented as a circular, one-dimension space that wraps around on itself. Colors that are 180 degrees apart from each other on this circle are complements of each other and share the least possible primary color content. Thus, the highest hue contrasts are obtained with two hues that are spaced 180 degrees away from each other on this circular space.

A second choice that is presented to the user is the degree of contrast desired between the brightness of the selected color and that of the resulting one. Brightness may be represented on a linear scale from 0 to 100%, where 100% is the maximum brightness available, and 0 is the absence of light.

A third choice that is presented to the user is the degree of color saturation desired for the resulting color. After the user makes these choices, the system displays a new color swatch that possesses the contrast characteristics selected by the user.

In a simpler implementation, the user is presented with a single choice-list of contrast options, each of which takes into account the three-parameter color space transformations to be made on the original color. Another implementation might present the user with a first choice-list of contrast options, each of which takes into account only two of the color space parameters to be transformed, and a second choice-list of contrast options for the remaining color space parameter.

Once the user selects the type of contrast transformation to be applied to the original colors, the system applies the transformation requested by the user through an internal algorithm to produce the resulting color. The system also uses a random logic algorithm to vary the resulting color such that it is slightly different with every activation of the same transformation selections. Thus, if the user performs this operation with the same swatch selection on consecutive tries, a different result may be obtained,
(g) Extract a color or a multiplicity of colors from an existing physical object by first acquiring an image of the object and subsequently selecting an area of the object as displayed on the screen. The area can be subdivided into color zones having equal or unequal geometry. The process then generates a color swatch for each of the color zones whose color is an average of the color of the original object within the bounds of the color zone. Additionally, the geometric relationships of the color zones can be preserved along with the corresponding matched color information. In consequence, a composite average color can be computed for all of the averages of the color zones.
(h) Find a product whose color characteristics approximate a selected color swatch. This option allows a user to locate those products whose color characteristics closely match those of a color swatch that is presently selected. The process then displays images of samples of the products that have color characteristics closely matching those of the selected color swatch.
(i) Select one of the product sample images as described in (h) for placement on the display with the color swatches generated above.
(j) Select one of the product samples chosen in (h) and (i) and request detailed information about the product.
(k) Select one of the product samples chosen in (h) and (i) for purchase.
(l) Rearrange the placement of the color swatches and product samples on the screen to permit a subjective evaluation of the combined aesthetic value of the colors and/or samples.
(m) Display all the items that the user has selected for purchase so that the color selections can be verified to be harmonious.

In summary, this invention allows an user to select colors into color swatches, find colors that harmonize with a selected color swatch, combine those color selections for storage and retrieval, search for products whose color characteristics closely match those of selected color swatches, display images of matched product samples, select the images of those product samples for the purpose of obtaining more detail about the represented product, select the images of those product samples for the purpose of purchasing the represented product, display samples of products already selected for purchase, and arrange the placement of color swatches and product samples on the screen to aid in the evaluation of color combinations and the combination of such products.

A color matching system in accordance with the inventive arrangements can include a swatch user interface for displaying at least one activatable color swatch for visually presenting a color corresponding to at least one color specification parameter specified according to a color characterization system; at least one color control for specifying the color specification parameters; and, a color matching module for computing a matching color based upon a color space matching parameter and color specification parameters corresponding to a color presented in an activated color swatch in the swatch user interface, wherein the color matching module can identify a color matching the color presented in the activated color swatch. Notably, the at least one color specification parameter can be user-selectable color space matching parameter.

Preferably, the color characterization system is the Hue-Saturation-Brightness (“HSB”) color characterization system. The color matching system also can include a swatch user interface for displaying the activatable color swatches and a plurality of color controls for specifying the color specification parameters. The color controls can include a hue control, a saturation control and a brightness control. Notably, the swatch user interface can include at least one network distributable document displayable in a Web browser. In addition, in the preferred embodiment, the activatable color swatch in the swatch user interface is repositionable within the swatch user interface.

Importantly, the color matching system can include at least one user-selectable color space matching parameter and a color matching module. Preferably, the user-selectable color space matching parameter can include a contrast parameter. Notably, the color matching module can compute a matching color based upon the user-selectable color space matching parameter and color specification parameters which correspond to a color presented in an activated color swatch in the swatch user interface. Significantly, the color matching module can identify a color matching the color presented in the activated color swatch.

In one embodiment of the present invention, the color matching system can include means for creating, saving, retrieving and deleting sets of color swatches displayable in the swatch user interface. In particular, sets of color swatches can be stored in “cookie” files in a client computer. In another embodiment of the present invention, the color matching system can include a color extractor for identifying an object's color. The color extractor can extract the object color from the object and can provide the identified color to the swatch user interface for display in a color swatch.

The color extractor can include an image acquisition device for acquiring a digitized image of an object; partitioning logic for subdividing the acquired digitized image into a plurality of color zones; and, color computing logic for computing a color for each color zone. As such, the color extractor can display each computed color in a color swatch in the swatch user interface. The color extractor further can include color averaging logic for computing an average color for each color computed for each color zone. Hence, the color extractor can display the average color in a color swatch in the swatch user interface. Finally, the color extractor can include a library of patterns for arranging the color zones in a selected portion of the acquired digitized image.

In yet another embodiment of the present invention, the color matching system can include a product database containing images of products and a product matching module. Each product shown in a product image can have at least one color. The product matching module can identify products in the product database having at least one color which matches the color identified by the color matching module. In consequence, the product matching module can produce a selectable set of the identified products. Finally, the color matching system can include shopping cart means for processing a check-out transaction for a selected product in the selectable set.

The color matching system can perform a method in accordance with the inventive arrangements. A computerized color matching method preferably can include receiving at least one color space matching parameter for matching a first color to a second color. The first color can correspond to color specification parameters defined in a color characterization system. Second, based upon the color specification parameters of the first color and the color space matching parameter, new color specification parameters can be computed. The new color specification parameters can correspond to said second color. As such, the second color can match the first color.

The computing step can also include computing new color specification parameters based upon the color specification parameters of the first color, the color space matching parameter, and a randomly generated value. As before, the new color specification parameters can correspond to the second color. However, by virtue of the randomly generated value, each time the computing step is performed the second color can differ from a second color computed in a previous performance of said computing step.

Notably, the computerized color matching method can further include the step of visually presenting to a user in a color swatch in a swatch user interface the first color corresponding to the color specification parameters defined in the color characterization system. Also, the color space matching parameter can be a user-specified color space matching parameter. In a preferred embodiment of the invention, the computerized color matching method can include the step of visually presenting the second color in a color swatch in the swatch user interface. Notably, each swatch in the swatch user interface can be repositioned within the swatch user interface. Also, the method can further include the step of displaying the color swatch in a swatch user interface in a network-distributable document displayable in a Web browser.

In the preferred embodiment of the invention, the color characterization system comprises a Hue-Saturation-Brightness (“HSB”) color characterization system. In addition, the computerized color matching method can further include the step of providing color controls for modifying the color specification parameters specifying the first color in the color swatch. Notably, the color controls can include a hue control, a saturation control and a brightness control. Moreover, the user-specified color space matching parameter can include a contrast parameter.

In one embodiment of the present invention, the computerized color matching method can further include the steps of: extracting an object color from an object and visually presenting the extracted object color in the color swatch. The extracting step can include the steps of optically scanning the object. In consequence, the optical scanning can produce a digital image of the object. Subsequently, color specification parameters can be determined which correspond to colors in a selected region of the digital image. The determining step can include the step of computing color specification parameters based upon an average value of the color specification parameters determinable in the selected region. Finally, a color can be identified according to the determined color specification parameters. Notably, the identified color will correspond to the object color in the selected region.

In another aspect of the invention, the extracting step can include optically scanning the object, the optical scanning producing a digital image of the object; subdividing a selected region of the digital image into a plurality of color zones; determining color specification parameters corresponding to colors in a each color zone in the selected region of the digital image; and, identifying a color according to the determined color specification parameters, the identified color corresponding to the object color in the selected region.

The visual presentation step can include visually presenting each identified color in a color swatch. Also, the method can include computing average color specification parameters based upon color specification parameters computed for each color zone; and, identifying an average color according to the computed average color specification parameters. Hence, the visual presentation step also can include visually presenting the average color in a color swatch.

The subdividing step can include retrieving a user selectable pattern from a library of patterns, the pattern specifying a spatial arrangement of color zones; and, subdividing the selected region of the digital image into at least two color zones according to the retrieved pattern. The subdividing step also can include subdividing the selected region of the digital image into a pre-selected number of color zones according to the retrieved pattern;

In another embodiment of the present invention, the computerized color matching method can include the steps of first, accessing a product database containing images of products, wherein each product has a color. Second, products can be identified in the product database which have a color matching the second color identified by the color matching module. Finally, a selectable set of the identified products can be produced. In consequence, a user selection of at least one of the identified products in the selectable set can be accepted, responsive to which an image of the selected identified product can be displayed in the swatch user interface.

Moreover, in yet another embodiment of the present invention, the displayed image can be positioned next to the first color in the color swatch in the swatch user interface. Furthermore, a user selection of at least one of the identified products in the selectable set can be accepted, responsive to which information related to the selected product can be displayed. Alternatively, a user selection of at least one of the identified products in the selectable set can be accepted, responsive to which each user selected product can be added to a shopping cart and a check-out transaction can be processed for each user selected product in the shopping cart.

Significantly, the invention is not limited to a Web-based implementation. Rather, both local area network and wide area network implementations of the color search method are within the scope of the present invention. Similarly, a stand-alone version of the present invention, too, is withing the scope of the present invention.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 is a schematic diagram illustrating a generalized architecture for a system for searching and producing matching color information.

FIG. 2 is a schematic diagram illustrating a computer network in which the system of FIG. 1 can operate.

FIG. 3 is a screen shot illustrating an exemplary user interface suitable for use in the present invention.

FIG. 4 is a screen shot illustrating an exemplary dialog box for saving a color set in the present invention.

FIG. 5 is a screen shot illustrating an exemplary dialog box for retrieving a color set in the present invention.

FIG. 6 is a screen shot illustrating an exemplary dialog box for performing a simple color match in the present invention.

FIG. 7 is a screen shot illustrating an exemplary dialog box for performing a two-choice color match in the present invention.

FIG. 8 is a screen shot illustrating the exemplary dialog box of FIG. 7 with a selected list box containing color characteristics.

FIG. 9 is a screen shot illustrating an exemplary dialog box for performing a three-choice color match in the present invention.

FIG. 10 is a schematic diagram of the present invention implemented with a multiplicity of software objects.

FIGS. 11 and 12 are circular plots illustrating hue range angle values.

### DETAILED DESCRIPTION OF THE INVENTION

In the present invention, a program or set of programs can identify a color in either a visual or logical fashion. Once a color has been identified, the program or programs can submit related color data to a color search engine. The color search engine can match the color data with products offered for sale that have similar color characteristics. Images of the matching products subsequently can be presented. Advantageously, the color search engine not only can match colors that are similar to an identified color, but also the color search engine can match colors that are complementary to other colors based upon configurable preferences. The complementary color matching feature of the color search engine can facilitate a search for colors that combine well with a first selected color. In this case, the color search engine can use the color data of the first selected color to identify colors that combine well with the first selected color, and additionally, display those products that have the color characteristics of the identified colors.

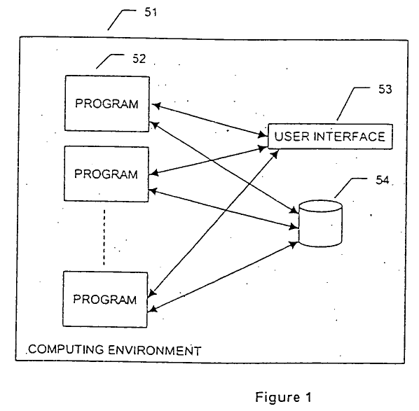

The present invention can be implemented in a computing environment 51 as illustrated in FIG. 1. The computing environment 51 can be comprised of one or more computers connected in a networked fashion, wherein the computing environment 51 can contain an operating system for each computer and a program or sets of programs 52 operating in concert that interact with a user through a user interface 53. FIG. 1 depicts several programs 52 in the computing environment 51. The programs 52 can combine to form an architecture based upon an event-driven model. More particularly, each of the programs 52 can receive and respond to one or more events in a stand-alone fashion. In particular, the programs 52 can respond to user-generated events which can be captured and communicated by the operating systems under which the programs reside.

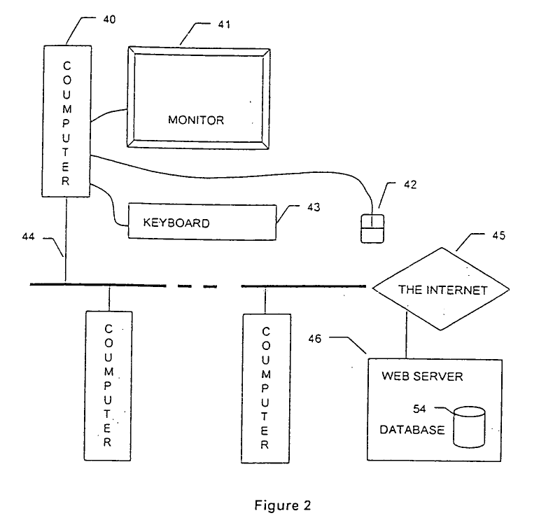

FIG. 2 illustrates a network topology of the computing environment 51 in which at least two computers are used—the user's computer 40 and the server 46. The computing environment 51 can be self-contained within a single computer 40. However, in an aspect of the present invention to be described herein, the computing environment 51 can incorporate the use of other computers through a network 44 and the Internet 45. In this case, the computing environment 51 can include the Internet 45 and one or more Web servers 46 that are connected to the Internet 45, a database 54 operating in one of the Web servers 46, and a computer 40 using a Web browser to present the elements of the user interface 53 to a user. Additionally, the user interface 53 can operate in a computer 40 that is equipped with a keyboard 43, a video monitor 41, and a pointing device 42 such as a mouse, track ball or other similar apparatus. Notably, in one aspect of the present invention, the invention can be implemented using software components residing both in a client environment in the computer 40 and at a Web server 46.

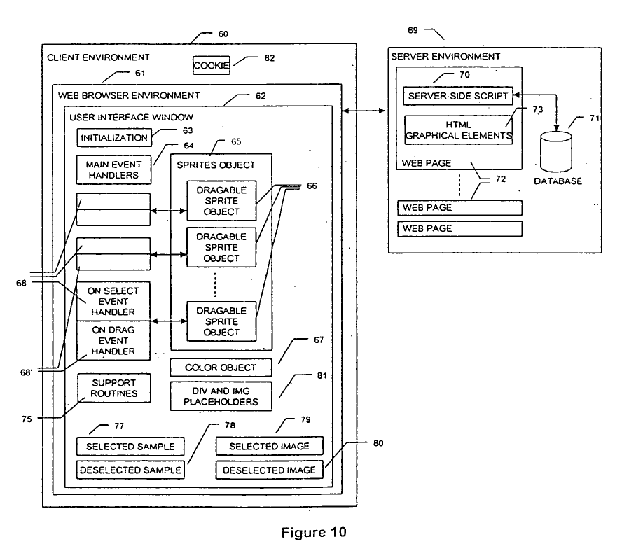

FIG. 10 illustrates the interaction between a client environment 60 in a computer 40 and a server environment 69 in the Web server 46. The client environment 60 can include a Web browser 61 for hosting the main portion of the user interface 53 illustrated FIG. 1 in a user interface window 62. The user interface 53 of FIG. 1 can be implemented using Javascript executing in the Web browser environment 61, albeit some computing can be performed in the Web server. Still, the invention is not limited in regard to the division of computing labor between the client environment 60 and the server environment 69. Rather, at one extreme, all processing can occur in the client environment with the server environment 69 acting merely as a database server. Alternatively, at the other extreme, all processing can occur in the server environment 69 with the client environment 60 acting merely as a terminal. In any case, the invention also is not limited to the computing language selected to implement the present invention. For instance, other possible implementations of the present invention can utilize components composed in Java, VBScript, Perl, C, etc.

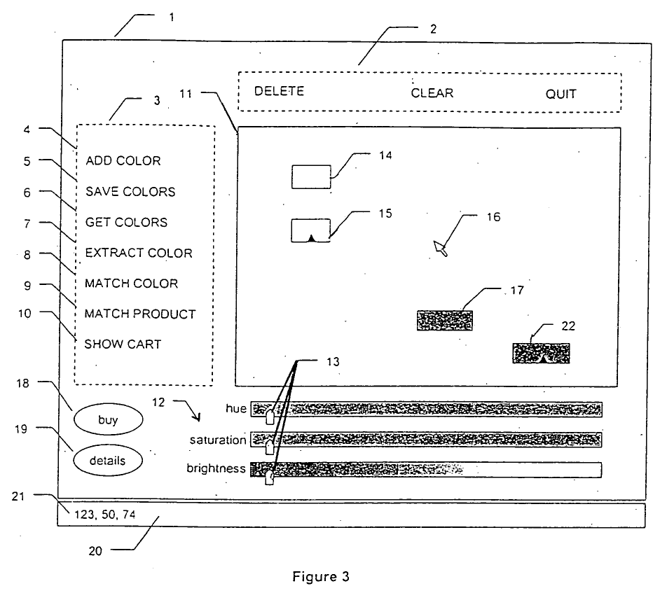

FIG. 3 is a screen shot of the user interface elements of the invention including a set of user menus 2, 3, a work-screen area 11 where color swatches 14 and 15, and product sample images 17 and 22 are created and displayed. The user is able to reposition these items anywhere within the boundaries of the work-screen area. The color controls 12 represent three parameters in the color-space used to identify the colors in the color swatches. The color content of the color swatches can be modified by sliding the slider/indicators 13 along the range of the corresponding color control. When the user selects a color swatch, the slider/indicators are automatically positioned to match the color content of the selected swatch.

The user interface can be presented to the user within a window 1 of a browser, for example the Web browser 61 of FIG. 10. Within that window, the user interface provides menus 2, 3 for the user to interact with the system. Preferably, the user can interact with the system in the manner that is common with other software programs' graphical user interfaces by directing a screen pointer 16 over the menu items that the user wants to activate. Referring to FIG. 2, the screen pointer 16 can be directed by means of a pointing device 42, such as a mouse, track ball or other similar device that is attached to the computer 40. The user activates the menu item by clicking an activation button on the pointing device 42 once the screen pointer 16 is positioned over the desired menu item.

Referring again to FIG. 3, the user is able to create color swatches 14 and 15 by activating the Add Color menu item 4, such color swatches being bounded areas within the user's work-screen area 11 that are filled with color. The user is able to select a particular color swatch, in which case such color swatch displays an indication of its being selected, for example, by placing a special graphic indicator on its border as shown in swatch 15. A swatch that is not currently selected displays a simple line border as with swatch 14.

Once a color swatch has been selected, the user can change its color content by using the three controls 12 at the bottom of the screen 1. The controls 12 are indicative of a range of motion for the slider/indicators 13, and the slider/indicators 13 are movable along the range of each corresponding control 12. The user performs the action of changing the color content of the selected swatch by placing the screen pointer 16 over the slider/indicator 13, clicking on the pointing device's proper button and dragging the slider/indicator 13 along the control until the swatch color is changed to the user's satisfaction. Each of the three controls change a different color characteristic, the first control affecting the hue, the second the saturation and the third the brightness of the color contained within the selected color swatch 15.

For the saturation and brightness controls, the slider/indicator's position along the control is linearly related to the amount of saturation and brightness respectively that the color swatch will display. For the hue control, the slider/indicator's position at the left side of the control corresponds to a color angle of 0 degrees as defined in a Hue Color Wheel. Specifically, hue contrast can be defined using the HSB color model, where the hue of a color is represented as a circular, one-dimensional space that wraps around upon itself. Colors that are 180 degrees apart from each other on this Hue Color Wheel are complements of each other and share the least possible primary color content. Thus, the highest hue contrasts are obtained with two hues that are spaced 180 degrees away from each other on the Hue Color Wheeler.

In the present invention, the left side positioning of the slider/indicator 13 can correspond to a color angle of 0 degrees—e.g. pure red. Notably, the color angle can increase proportionally to the movement of the slider/indicator as the slider/indicator is moved toward the right until it reaches 360 degrees, this corresponding again to pure red. As any of the control sliders 13 can be dragged along the corresponding control 12, an indication of the current value of the control is displayed in the status area 20 of the Web browser. Moreover, the effect of the adjustment of the controls 12 can be displayed in the form of color changes in the selected color swatch 15.

The user is able to click and drag a selected color swatch around within the bounds of the work-screen area 11, juxtaposing the swatches in such a way as to make good judgements of the effectiveness or harmony of the colors contained in the swatches. When a color swatch is selected by clicking the pointer device's button when the screen pointer 16 is within its boundaries, its color values 21, which are representative of the hue, saturation and brightness levels of the swatch are displayed on the status display area 20 of the Web browser. Accordingly, the positions of the slider/indicators 13 are changed to correspond with the color values of the selected swatch along the corresponding controls 12.

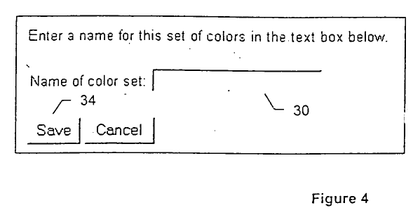

Once a user is satisfied with a selection of colors, the user is able to save the contents of the work-screen area 11 by activating the Save Colors menu item 5, preserving all the color swatches, their color content and their positions within the work-screen area. When activating the Save Colors menu item 5, the user is presented with a dialog box, as shown in FIG. 4, containing a text box 30 for the user to type in a unique name for the set of swatches being saved.

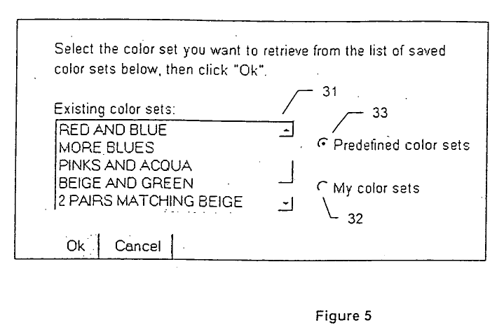

The user is later able to retrieve this set of swatches by activating the Get Colors menu item 6. When the user activates the Get Colors menu, the user is presented with a dialog box as shown in FIG. 5 which contains a choice-list 31. When the user selects the radio-button labeled My color sets 32, the choice-list will display all the color swatch sets the user has previously saved. The user can then select an item of the list and retrieve the color swatch saved under the name displayed in the choice-list. The color swatches retrieved in this manner will retain the positions they originally occupied in the work-screen area 11 at the time they were saved. Alternatively, the user may retrieve pre-stored color sets that are provided by the server by selecting the radio-button labeled Predefined color sets 23.

The Extract Color menu 7 allows the user to use a scanner, video camera or other similar device capable of capturing video images into a computer's storage and extract a color from the captured image. The user is then presented with a crosshair cursor that allow the user to enclose the area of the image that contains the desired color. The enclosed area can be subdivided into color zones for which corresponding colors values can be computed. Subsequently, a color swatch can be displayed for each color zone. Additionally, an average color value can be computed for the color values of each corresponding color zone. Alternatively, the system can compute an average set of color values for the color content of the entire enclosed portion of the image and places it into a new color swatch. The new captured color can then be matched as described before.

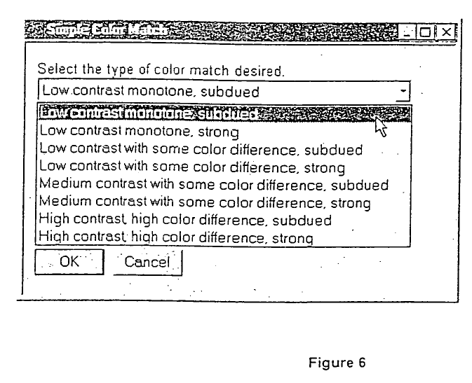

As shown in FIG. 6, the Match Color menu 8 provides the user with a method of finding new colors that can be combined with the color in the currently selected color swatch in a pleasant and harmonious way. Although the aesthetic characteristics of color combinations are subjective, the user is able to request that the system find aesthetically pleasing color combinations based on either pre-defined or selectable preferences with regard to hue contrast, saturation contrast and brightness contrast between the colors. In a simple embodiment of this feature of the invention, upon activating the Match Color menu 8, the user is presented with a simple choice-list of contrast options, each of which takes into account the three-parameter color space transformations to be made on the original color. Once a choice is made, the system uses an algorithmic transformation described later that results in the presentation of a new color to the user, such color being in accordance with the contrast options chosen by the user.

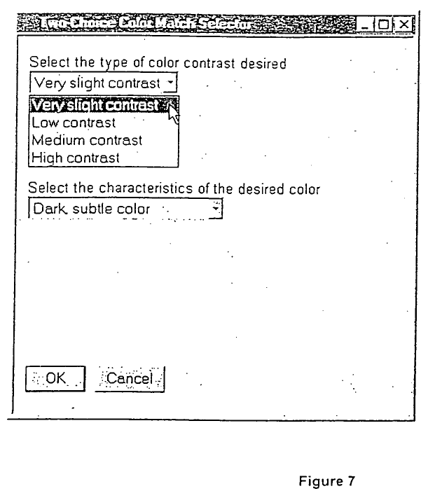

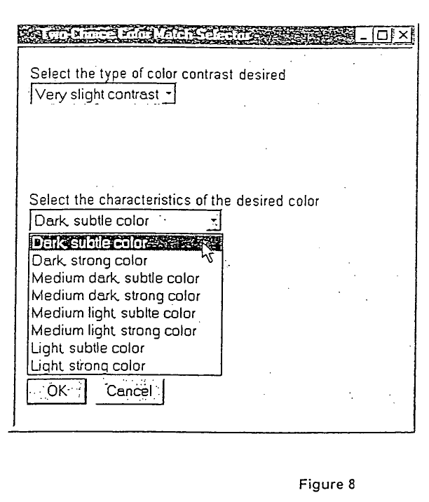

As shown in FIGS. 7 and 8, in an alternative embodiment of this feature of the invention, upon activating the Match Color menu 8, the user is presented with a first and second choice-lists of contrast options, the first choice list containing a list of options that take into account only one-parameter of color space transformations to be made on the original color, and the second choice list containing a list of options for the remaining two parameters of color space transformation to be made on the original color, as depicted in FIGS. 7 and 8.

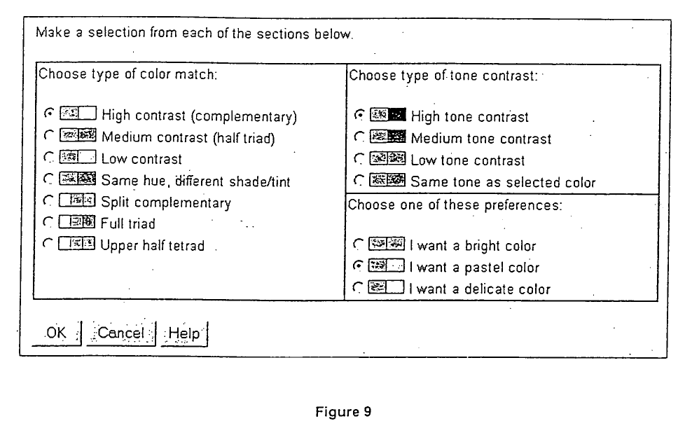

As shown in FIG. 9, in a third embodiment of this feature, the user is given more precise control over the transformation between the selected color swatch and the resulting color by presenting the user with discrete choices for each of the three color space parameters and their respective transformations. The Match Product menu 9 provides the user with a method to identify a list of products available for purchase whose color characteristics are associated with those of a selected color swatch on the work-screen area 11.

When the user activates this menu, the system searches the database 54 depicted in FIGS. 1 and 2, and using an algorithmic method, identifies products whose color characteristics are associated with those of the selected color swatch on the work-screen area. If matches are found, the user is presented with a list of products with the desired color characteristics, accompanied by product sample images of the product, for selection by the user. Once the user selects one of the product samples from the list, the selected product sample image 17 is then displayed in the work-screen area 11. Alternatively, if the found product matches are not too numerous, the sample images of the available matches found can be directly displayed in the work-screen area 11.

The user has the ability to click and drag the color swatches 14 and product sample images 17 anywhere inside the boundaries of the work-screen area 11, to arrange them in a way that is conducive to making good color comparisons and selecting color and product combinations that are aesthetically pleasing or desirable. Advantageously, the system can include a virtual shopping cart that contains the products the user has selected for check out. The Show Cart menu 10, when activated, places into the work-screen area 11 product sample images 17 of the products the user has selected for purchase. These product samples can then also be arranged at will anywhere around the work-screen area. As with the color swatches, the user is able to select a product sample 17. When a product sample is selected, an identifiable border is displayed around the product sample image 22 as an indication that the sample is selected.

The buy button image 18 is active when a product sample 22 is selected. When the buy button is clicked, the selected product sample is marked for purchase and placed in the virtual shopping cart. Likewise, the details button image 19 is active when a product sample 22 is selected. When the details button is clicked, the user is presented with detailed information about the product whose sample is selected. Such detailed information can include regular price, sale price, description, size, color, product code, catalog number, inventory availability and a more detailed image of the product item.

The DELETE, CLEAR and QUIT menu selections in menu 2 operate as follows. The DELETE entry will delete a selected color swatch or product sample; the CLEAR entry will clear the entire work-screen area of all color swatches and product samples and leave a blank work-screen; and the QUIT entry will terminate the use of the user interface of the system by closing the Web browser window in which the user interface is operating.

Referring to FIG. 10, the system and method in accordance with the inventive arrangements preferably can be implemented using object-oriented software design techniques well known in the art including using a multiplicity of software objects that are declared and subsequently instantiated in the software of the present invention. FIG. 10 depicts three primary types of objects in the present invention: a dragable sprite object 66, a sprites object 65 and a color object 67. The dragable sprite object 66 implements a movable item in a swatch user interface window 62 such as a color swatch (FIG. 3, 14), a product sample (FIG. 3, 17), and a slider/indicator (FIG. 3, 13).

The dragable sprite object 66 can be used to store the corresponding item's current position, status, pointers to event handler code, and boundaries of permitted movement. Every movable item on the swatch user interface window 62 can be associated with a single dragable sprite object 66 wherein each movable item and dragable sprite object 66 have a one-to-one correspondence. Each of the dragable sprite objects 66 can contain a pointer to an on-select event handler 68 and an on-drag event handler 68′. The on-select event handler 68 can be invoked as a result of a browser mouse-down event occurring when the screen pointer is within the screen area occupied by the corresponding movable item. The on-drag event handler 68′ can be invoked as a result of a browser mouse move event occurring when the screen pointer is within the screen area occupied by the corresponding movable item, but only if a corresponding mouse-down event has been detected.

The sprites object 65, preferably can be implemented as a singleton container object containing a collection of all dragable sprite objects 66 in use by the swatch user interface 62 at any point in time. The sprites object 65 can also include methods for manipulating the dragable sprite objects 66 in a consistent manner to effect the selection and movement of the corresponding items on the swatch user interface window 62, and to react to those actions appropriately by executing the corresponding event handlers in the dragable sprites object 66.

The color object 67 also can be implemented as a singleton container object. The color object 67 can store color-space data for a single color. Furthermore, the color object 67 can accept and return such color information in a variety of color-space formats. Thus, the color object 67 can facilitate color-space transformations. Initialization code 63 can instantiate each of the above identified objects. Additionally, initialization code 63 can initialize the main event handlers 64, in addition to the computing environment. The main event handlers 64 can capture appropriate browser events and generate proper responses to handle the swatch user interface 62 and manipulate movable items therein.

In the preferred embodiment, a collection of Web pages 72 resides in the server 69. The Web pages 72 contain event-driven programs referred to in the art as server-side scripts 70. Additionally, the Web pages 72 can contain the HTML elements of the swatch user interface 62. The server-side scripts 70 can respond to user requests, and interface with a products database 71 containing product details and color-space information for products.

In one particular implementation described herein, a user can begin by requesting the main swatch user interface page 70 from the server 69. The server 69 responds to this request by executing a server-side script 72 for verifying that the main swatch user interface page 70 is being requested from a valid source Web page. In addition, the server-side script 72 can initialize certain HTML elements of the response based on initial conditions. Upon successful validation and initialization, the server 69 can serve the Web page containing the swatch user interface 70 to the user or client.

Notably, in its source code form, the main swatch user interface page 70 can incorporate graphical elements 73 coded in HTML, server-side script code 72 for execution in the server 69, and client-side script code to be executed in the client 60. The client-side script code can include initialization code 63, main event handlers 64, and other objects and handlers 65, 66, 67 and 68. The graphical elements 73 and client-side script code, including those elements shown within the swatch user interface window environment 62, can execute in the client 60 in a Web browser 61.

When the Web browser 61 receives the main swatch user interface 70 from the server 69, the graphical elements 73 of the page are displayed by the Web browser 61, and the initialization code 63 is executed. The initialization code 63 creates the Javascript object referred to above as a sprites object 65, which can contain a collection of other Javascript objects referred to above as dragable sprite objects 66 that are used to display, control and reposition the color swatches, product samples and slider/indicators 13, 14, 15, 17 and 22 of FIG. 3. The initialization code 63 also can establish linkages between user directed events and portions of code in the main event handlers 64, such that the occurrence of these events will invoke the corresponding code within the main event handlers. These user directed events are the activation of a button on the user's pointing device 42 of FIG. 2, the dragging of the pointing device 42, the dragging of the pointing device 42 while the main pointing device's button is depressed, and the release of the pointing device's main button.

Another function of the initialization code is to create and initialize blank dynamic HTML (DHTML) elements 81 on the page as placeholders for the color swatches and product samples. These are comprised of a DIV element (HTML <DIV> tag) and an IMG element (HTML <IMG> tag) contained within the DIV element that is initialized to an empty, transparent image. Although these elements are generated dynamically in the initialization script, the equivalent resulting HTML code can be as follows.

<STYLE type=“text/css”>
#dv1 {position:absolute; left:100; top:100; height:30; width:50;
background-color:white}
</STYLE>
<DIV id=“dv1” height=“30” width=“50”><IMG id=“ic1” name=“ic1”
src=“blank.gif”></DIV>

where the numerical constants for top and left positions will vary for each element generated, and where the id's dv1 and ic1 will also vary for each element. Additional variations of this code may be needed to accommodate differences between Web browsers. This key set of HTML elements use CSS (Cascading Style Sheets) positioning and Dynamic HTML (DHTML) capabilities of modern browsers to enable the user interface code to change the color of the color swatches, and reposition the color swatches and product samples anywhere within the Web browser window without repainting the entire window. This is done by assigning values during code execution to the corresponding properties of any one of these DHTML elements.

The same technique is used to implement the movement of the slider/indicators 13 of FIG. 3. The color swatches, product samples and slider/indicators 13, 14, 15, 17 and 22 of FIG. 3 are made movable by use of this technique in conjunction with the properties and methods implemented in the sprites object 65 and the dragable sprite objects 66. These two objects preferably operate as follows.

One dragable sprite object 66 can be created and assigned for every movable element on the user interface window. The properties of a dragable sprite object hold the following parameters.
a. The current absolute x and y position of the corresponding element.
b. The ID (HTML ID property) of the corresponding HTML DIV tag.
c. The ID of the corresponding HTML IMG tag.
d. A flag to indicate whether the element represents a “selectable” item. Color swatches and product sample images are selectable, while slider/indicators are not.
e. The absolute upper, lower, leftmost and rightmost boundaries of motion or positioning for the corresponding element.
f. For a selectable item, a name pointer to the image to be assigned to the corresponding DHTML IMG element's SRC property when the element is selected.
g. For a selectable item, a name pointer to the image to be assigned to the corresponding DHTML IMG element's SRC property when the element is deselected.
h. A name pointer to an on-select handler 68 to be invoked when the main event handlers 64 trap a browser-generated mouse-down event, which is triggered when the user clicks and therefore attempts to select an element.
i. A name pointer to an on-rag handler 68′ to be invoked when the main event handlers 64 trap a browser-generated mouse-move event, which is triggered when the user drags an element around the user interface window.

The color properties for each DIV element preferably are not stored in the dragable sprite object 66, since this property is already stored and is easily accessible by interrogating the DHTML background color property of the element. The sprites object is a single container object that contains the total population of dragable sprite objects 66, and manages their creation and manipulation. Its primary properties hold a list of pointers to the dragable sprite objects 66, a name pointer to the currently selected dragable sprite object 66, and other auxiliary properties. The sprites object supports several methods as follows.
a. An add method used to add a dragable sprite to the collection.
b. A select method used to handle a browser mouse-down event. The select method first tests to see if the user clicked over a movable DHTML element that corresponds to a dragable sprite in the sprite object's collection. If so, the select method performs any functions that must be executed to select an element, such as changing the SRC property of the corresponding DHTML IMG element to visually represent the selection, and then executes the corresponding dragable sprite object's on-select handler. The internal state of the sprites object is changed to reflect the fact that a mouse-down event occurred over a valid movable element. While in this dragging state, any mouse-move events will be treated as a dragging action.
d. A move method to reposition an element. This method is invoked when the main event handlers trap a browser-generated mouse-move event. If the sprites object is in a dragging state, the currently selected movable element will be repositioned accordingly, and the corresponding dragable sprite object's on-drag handler will be invoked. The new position is computed based on the displacement of the screen pointer from its last position, moving the corresponding movable item an equal amount, provided that its boundaries of motion are not exceeded. To implement this, the newly computed position is compared to the boundary parameters in the corresponding dragable sprite object. The height and width of the movable item are taken into account so that the entire movable element can be contained within the corresponding boundary parameters. If the boundaries of motion are exceeded, the movable item is forced to remain within those boundaries.
e. A release method invoked when the main event handlers trap a browser-generated mouse-up event. If the sprites object is in a dragging state, the release method returns the object to its normal state.

When the user activates the Add Color menu item 4 of FIG. 3, the click action invokes a portion of the main event handlers 64, which in turn invokes a support routine 75 that creates a color swatch. The creation of such color swatch involves the steps of:
a. Identifying an unused DHTML element placeholder 81 on the user interface window environment 62 to contain the color of the swatch and the image of its border,
b. Initializing an unused DHTML DIV element with an initial background color, using an associated BG color property.
c. Initializing the DIV element's contained IMG element with the image of a selected color swatch border as in 15 of FIG. 3, such image using GIF format and containing a transparent area within the border so that the background color of the DIV element shows through,
d. Creating a new dragable sprite object 66 that is linked to the corresponding DIV element and contains information about said DIV, including its current screen position, unique identifier name, name-pointer to an on-select event handler 68, name pointer to an on-drag event handler 68′, and boundaries of motion. The boundaries of motion for a color swatch are made to correspond with an area largely occupying the work-screen area 11 of FIG. 3.
e. Adding the new dragable sprite object to the collection within the container sprites object 65.

The sprites object 65 can continue to build the collection of dragable sprite objects 66 each time a new color swatch is added by the user through the Add Color action, thus maintaining information about all color swatches on the screen, including their current position. When a new color swatch is added, the previously selected color swatch must be deselected. This action is performed by
a. changing the SRC property of the corresponding DHTML IMG element to display a plain border image as in FIG. 3-14, said image being in GIF format and containing a transparent area within the border to allow the background color of the corresponding DIV element to show through.
b. Storing a pointer to the newly selected element and corresponding dragable sprite object 66 in the status parameters of the sprite object 65.

Once a color swatch is added, it becomes the selected swatch. The color of the swatch is set to an initial color having corresponding color parameters, for example 123, 50, 74. The user may change the selected swatch's color by clicking and dragging the color control slider/indicators 13 of FIG. 3. The slider/indicators can be implemented by using dedicated movable DHTML elements and associated dragable sprite objects 66 as described herein. The top and bottom boundary parameters of the associated dragable sprite objects 66 preferably are set such that no vertical motion is possible, and the left and right boundary parameters preferably are set such that the range of possible horizontal motion of the DHTML element corresponds to the range of the controls 12.

When the user first selects a slider/indicator in preparation for a dragging motion, the browser can trigger a mouse-down event. Such event is trapped by the main event handlers 64, which in turn invokes the select method of the sprites object 65, indicating to the software that the user may be preparing to move the slider/indicator. When the user attempts to drag the slider/indicator along its range, the dragging action causes the browser to trigger a mouse-move event. A portion of the main event handlers 64 traps this event, which in turn calls the move handler of the sprites object 65, which in turn calls the on-drag handler of the corresponding dragable sprites object 66, passing the new coordinates of the screen pointer to the on-drag handler for processing. The on-drag handler then uses these coordinates to compute a new value for the corresponding color-space parameter, and changes the background color of the DIV associated with the currently selected color swatch accordingly using DHTML capabilities of the browser.

Each of the three slider/indicators affects one of the HSB color space parameters corresponding to the color of the selected swatch. However, since the background color parameter for the DIV element that realizes the color swatch on the screen does not accept HSB values, a color object 67 is used to facilitate color space transformations. The color object 67 preferably is a singleton object that encapsulates a color value. This value can be stored or retrieved in either RGB, HSB or 24-bit packed RGB formats, allowing easy manipulation of color.

When the user activates the Save Colors menu item 5 of FIG. 3, the click action invokes a portion of the main event handlers 64, which in turn performs the following actions.
a. Encoding the data contained within the sprites object in the collection of dragable sprite objects that represent the color swatches currently on the screen into a serialized format as shown below, including information about each dragable sprite object such as its corresponding DIV element, the background color of the DIV element, its screen position, its screen z-order and an indicator of whether it is currently the selected swatch: dv1, 173, 107, c1e9cc, 110|dv2, 283, 242, daa8b6, 103|dv53, 392, 184, bds62, 109
b. Launching a new Web browser window.
c. Submitting the encoded serialized data in a to the server in the URL portion of the request for the page to be displayed in the new window of b.
d. Along with the submitted information, the browser also submits any cookies, if present on the client environment 60 that are associated with the path of the requested page.

The page requested from the server in the above steps then displays in the new browser window as in FIG. 4, prompting the user to submit a unique name for the color set to be saved, and containing an HTML form identified by the <FORM> tag to post the unique name back to the server upon the user clicking the Save button. When the user submits the form, the server receives the name the user entered and the encoded serialized data representing the information about each dragable sprite object 66, including its corresponding DIV element's ID, the background color of the DIV element, its screen position, and its screen z-order.

The z-order parameter is a DHTML property of any DHTML element and is indicative of its ability to obscure other objects as they overlap positions on the screen. An element with a higher z order value always obscures one with a lower value when their positions overlap. Since the z-order of a color swatch or product samples is changed to be the highest of all the objects within the work-screen area when it is selected, the element with the highest z-order is the one that is currently selected.

When the server 69 receives the data posted by the form in the new window, a server-side script encodes the previously received encoded serialized data representing the color swatches currently on the user interface screen into a saved sets cookie 82 if one is already present, or into a newly created saved sets cookie 82 if one is not present. The saved sets cookie 82 is in turn sent back to the client for storage as a response to the user's submission. As the user saves more color sets, the information stored in this saved sets cookie 82 ultimately contains the data and names for all saved color sets existing on the client environment. Thus, every user's computer accessing this system can preserve its own unique color sets as saved by the user. The saved sets cookie 82 preferably can be structured as a data dictionary with key values corresponding to data sets. The key values are the color set names assigned by the user, and each corresponding data set contains the serialized data associated with the saved color set.

When the user requests a previously saved or a pre-defined color set, the server returns the serialized data corresponding with the color set embedded in a client-side function call argument as follows.
reloadColrs(“dv1, 173, 107, c1e9cc, 110|dv2, 283, 242, daa8b6, 103|dv53, 392, 184, bds62, 109”);

The client-side reloadColrs function is a routine that deserializes the encoded data and recreates the corresponding DHTML elements and dragable sprite objects 66 that correspond to the color set retrieved, thus reconstructing the contents of the screen work-area when the color set was saved.

Product samples are treated very much the same as color swatches. Each product sample is associated with a dragable sprite object 66 and a DHTML DIV element containing an IMG element. Each dragable sprite object 66 corresponding with a product sample is also contained within the sprites object 65. One notably difference between the implementation of a color swatch and a product sample is that the SRC property of a product sample's corresponding IMG element points to a non-transparent image of the product. Two images are provided for each product sample: one showing a selected border as shown in 21 of FIG. 3, and one with a plain border as shown in 17 of FIG. 3.

The serialized data for a product sample can be slightly different than that of a color swatch. For a color swatch, the serialized data preferably contains the color content in 24-bit packed RGB. In the case of a color sample, the corresponding data element contains the name of the image file containing the image of the product sample, with the file extension excluded. Color values and image names are distinguished by using characters in the image name that cannot occur in a packed, ASCII-coded hexadecimal value. To fetch the selected version of the product sample image, an “s” is appended to the name.

Thus as shown above, the following encoded serialized data is interpreted as follows. Each movable element's data (a color swatch or a product sample) is delimited by a pipe (|) character. Each element's data has 5 parts, which are in turn delimited by a comma as shown below.
dv1, 173, 107, c1e9cc, 110|dv2, 283, 242, daa8b6, 103|dv53, 392, 184, bds62, 109
   where, dv1 is the ID of the first color swatch's DIV element, 173, 107 are the x and y coordinates of the color swatch on the work-screen area, c1e9cc is the 24-bit packed RGB value of the color, expressed in ASCII-coded hexadecimal values, 110 is the z-order of the swatch's DIV element on the browser's screen, and for a product sample, where dv53 is the DIV ID for the product sample, 392, 184 are the x and y coordinates of the product sample on the work-screen area, bds62 is the name of the image file for the color sample, and 109 is its z-order.

The extract color menu 7 provides a user interface for performing a color extraction process. Specifically, in the preferred embodiment, an optical scanner can be linked to the system through a TWAIN interface. Through the TWAIN interface, the optical scanner can be commanded to scan a colored object, the scanning resulting in a digitized image of the colored object. Subsequently, the color can be extracted from a selected portion of the digitized image and provided to the system. Preferably, the extracted color can be visually disposed in a color swatch.

Notably, the selected portion of the digitized image can be subdivided into smaller areas referred to as color zones. Each color zone can have a geometrically uniform or non-uniform shape for example a square, rectangle, octagon, etc. As a result, a color can be extracted for each color zone using only data associated with the color zone. Finally, a color swatch can be generated for each of the color zones and placed in the work-screen area. Additionally, an average color for all of the color zones can be computed and visually displayed in a color swatch.

In one implementation of the color extraction process, the color zones can have uniform geometric shapes matching the shapes of items that will be used to assemble a finished work, such as a quilt, a stitching project, or a project involving paint or beads. In the case of a quilt, for instance, the color zones can be geometrically shaped to match the shape of those portions of fabric used to form the quilt. In this way, fabric colors of a quilt can be selected to accurately match the color of an accessory, for example curtains or a lamp. More particularly, the accessory can be scanned from which a set of color swatches can be displayed on the work-screen area. Notably, the color swatches can include both the color swatches for the color zones in addition to a color swatch for the entire selected portion of the accessory. Subsequently, fabric data and imagery can be retrieved from a database and displayed in the work-screen area. Significantly, the fabric data and imagery retrieved can match not only the colors of the swatches of corresponding color zones, but also the colors of the swatch for the entire selected portion of the accessory.

A further implementation of the color extraction process, can include a library of geometric shapes and patterns of shapes for use in subdividing a selected portion of a scanned object into color zones. In particular, patterns in the library can include stitching patters or bead patterns, to assist in matching the overall color scheme of a multi-colored fabric or bead arrangement. For instance, in the case of the bead pattern, the pattern can include shapes formed according to the shape of each bead and the stitch used to assemble the beads.

In operation, a user can browse or search the library of patterns from which a pattern can be chosen. Once a pattern has been chosen, the user can specify a number of shapes to be included in the pattern. Finally, the user can select a portion of the scanned image as displayed on the work-screen area. In consequence, the selected portion can be subdivided into the specified number of smaller areas having the specified shape and arrangement according to the pattern selected from the library.

The match color process invoked by menu item 8 in FIG. 3 can be implemented as follows. When the user activates this menu option, the mechanisms described previously herein activate the portion of the main handlers designed to respond to the user request. The code then opens a new browser window to prompt the user for the type of transformation desired, also described previously. FIGS. 6, 7, 8 and 9 provide examples of possible prompts, starting from the simplest type of prompt to a more advanced form. In all cases, when the user submits the response form, the server executes server-side color match script to compute an appropriate transformation on each of the selected color swatch's color-space parameters.

In the preferred embodiment of the invention, the color match script performs the following transformations: For hue, the transformation can be described by the formula Hₙ=Hₛ+Sᵣ×(deltaH+R×rnd) where Hₙ is the new hue, Hₛ is the hue of the currently selected color swatch, Sᵣ is a randomly generated value that is either +1 or −1, deltaH is a hue displacement value that is dependent on the user's desired contrast selection as described below, R is a randomizing scalar as described below, and rnd is a random value between −0.5 and 0.5.

| | | |
|---|---|---|
| User's contrast selection | Value of deltaH | Value or R |

| | | | |
|---|---|---|---|
| H (high) | 180 | degrees | 30 |
| M (medium) | 120 | degrees | 30 |
| L (low) | 60 | | 30 |
| S (same) | 0 | | 10 |

The value of deltaH is selected to deflect the new hue to a place on the color circle that is proportionally displaced from the current hue according to the user's selection. For a high hue contrast H, a half circle displacement is selected, for medium M 120 degrees, 60 degrees for low L, and 0 for S. R is simply a randomizing constant that establishes the maximum value of the random component of deflection for the new hue from the current hue. So for example, for a high, medium or low hue contrast selection, the displacement will be randomized by <15 degrees. When the user selects no hue contrast, R is set up so that only a small random component is introduced of <5 degrees just to introduce a small variance between the current and new colors, while maintaining the general hue of the current color.

In the more advanced implementation illustrated by the choices shown in FIG. 9, the user may select transformations that are generally know as split complimentary, full triad and upper half tetrad. These transformations require new color hue displacements of <150 degrees, <120 degrees and <60 degrees around the color circle. Therefore, these transformations return two new colors rather than one, but use the same randomizing technique described above.

For brightness, the transformation used in the preferred embodiment is similar to that of hue, except that the range of the brightness parameter has an upper bound of 100% and a lower bound of 0%. For a high level of contrast, a 50% nominal deviation from the current color's brightness is selected, followed by 33%, 17% and 0% for medium, low and same selections respectively as illustrated in FIG. 9. The deviation is then randomized by a value between M. If the resulting deviation is too large to be added to the current value without exceeding the parameter's upper bounds, the value is subtracted and vice-versa. If both adding or subtracting is possible, one choice is selected at random. Since colors below a brightness of 30% tend to appear black on a computer monitor, resulting values between 0% and 50% are further scaled proportionally to fall between 30% and 50% as follows Bₙ=Bₛ×0.4+30 where Bₙ is the new brightness value and Bₛ is the currently selected color's brightness value. Other possible solutions for brightness transformations are possible. For saturation, the script computes the transformation according to the following code.

randS = 0.25,
cS = deltaS/100 − randS/2 + randS*Rnd,
if (cS > 1.00), cS = 2−cS
if (cS < 0.00), cS = −cS

where randS is a randomizing value, cS is the resulting saturation value and deltas is selected according to the user's selection as follows:
For a bright color (high saturation), deltas=83For a pastel color (medium saturation), deltaS=50
For a delicate color (low saturation), deltas=16

The last “if” statements ensure that the resulting values are not above 100% or less than 0%. If they are, the resulting value is further transformed. Since saturation values below about 20% tend to look gray with brightness values less than 50%, the resulting value is further scaled for the conditions that the resulting saturation value is below 35% as follows.
if (cB <0.5 And cS <0.35), cS=cS+1.0*(0.5−cS)*(0.6−cB) where cB is the resulting brightness level.

Significantly, the present invention is not limited to the above-described color matching algorithms. Rather, the above-described algorithms are determinable on the basis of best empirical performance for a particular application. Notably, many similar transformations are possible to optimize results on different applications. Accordingly, other suitable algorithms for color matching can be substituted for those algorithms described above.

The match product process invoked by menu item 9 in FIG. 3 can be implemented as follows. When the user activates this menu option, the mechanisms described previously herein activate the portion of/the main handlers designed to respond to the user request. The code then submits the request to the server, passing the color data for the currently selected color swatch. A server-side script then submits a Structured, Query Language (SQL) query to the product or item database as follows.

SELECT Item_ID FROM Items WHERE (Hue_ID = Hue_Low_Index
OR Hue_ID =
Hue_High_Index OR Hue_ID = Hue_Center_Index) AND
(Color_Saturation BETWEEN s−5 AND
s+5) AND (Color_Brightness BETWEEN b−5 AND b+5)

where s is the saturation parameter value for the currently selected color swatch, Color_Saturation is the name of the corresponding saturation parameter in the database, b is the brightness parameter value for the currently selected color swatch, Color_Brightness is the name of the corresponding brightness parameter in the database, and the hue parameters are substituted based on the algorithm described below.
The expressions “BETWEEN b−5 AND b+5” and “BETWEEN s−5 AND s+5” establish a <5 search range for the corresponding brightness and saturation parameters. The result is that the database will return the item ID's for items whose brightness and saturation parameters are within <5 of the values b and s respectively.

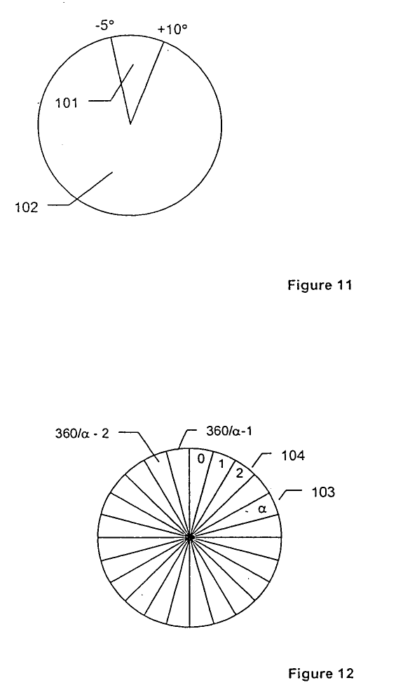

Since the hue dimension of the color is circular, a SQL statement cannot provide a simple search range description with the use of the BETWEEN construct as was used for the brightness and contrast parameters. This is because in the database, the hues must be stored using a single arbitrary valid range of color angle values, although the range of −2<<0<2<is desirable to express ranges that span across the 0 degree point. However, the range −2<<0 <2<has duplicate values or points on the circle, precluding the use of single unique values for each item in the database. For example, the values −10 degrees and +350 degrees constitute an equivalent point on the circle, but the most expedient way to store these values is to use a single value corresponding to the first 0 to 2<cycle of the circle, or 0 to 360 degrees. Therefore, in SQL, the clause “BETWEEN −10 and 5” would fail, since there would be no negative values in the database. Similarly, the clause “BETWEEN 5 and 350” would yield erroneous results, because it would fetch items with hue values completely outside the desired range, as in 102 of FIG. 11, rather than those within the desired range 101.

Referring to FIG. 12, the solution used in the preferred embodiment sections the hue circle into N equal segments of an arbitrary angle <, such that 3 contiguous segments or a greater odd number of contiguous segments constitute the width of the selection range desired. Each segment is assigned an index from 0 to N−1, where N=360/<. Each item in the database has its hue value stored as a hue index equal to the corresponding segment's index as in FIG. 12. A simple algorithm then takes the index of the color to be searched, identifies it as Hue_Center_Index, computes the index of the segment immediately adjacent in the counterclockwise direction as Hue_Low Index, the index of the segment immediately adjacent in the clockwise direction as Hue_High_Index, and substitutes the values in the SQL statement above. This greatly simplifies the query specification and minimizes the database computation overhead. The resulting item's color hue will be within the tolerance of <2<. This is derived simply by observing that the item's hue index classification introduces an error E in the range of 0<E<<, since the actual color's hue angle may be anywhere in that range. By selecting the two adjacent segments as valid index values in the search, an additional deviation of <is added. Therefore, the error can be as great as −2< if the resulting item's original hue error is <, or +2<if the resulting item's original hue error is 0.

By dividing the circle into the right number of equal segments, the search tolerance can be adjusted as desired. In the preferred embodiment, the circle is divided into 72 segments of 5 degrees, providing a search variability of <10 degrees. As a result, a user may find an item in the database whose hue characteristics are within <10 degrees of the currently selected color swatch, (the desired color). This is an adequate tolerance for most applications, but it can obviously be adjusted for more precision, without placing additional burden on the database.

When the database returns a set of records matching the desired criteria, the server-side script presents the available choices to the user in a dynamically created page, showing the sample images and descriptions of the matching items. The items listed should closely match the desired color characteristics exhibited by the currently selected color swatch. The user may then select one or more items to place in the work-screen area 11 of FIG. 3. These sample images will be displayed as the product samples 17 and 22 in FIG. 3. The user may subsequently reposition these around the screen using the mechanisms shown herein to make subjective comparisons and aesthetic judgements on the value of the combinations of color swatches and product samples shown. The user may also select one of the product samples and place it in the virtual shopping cart by clicking button 18 in FIG. 3.

The show cart menu entry 10, is implemented by fetching the item ID's for product items already in the virtual shopping cart, and calling procedures similar to those described herein to incorporate a new color swatch. Slight variations of the code account for the differences in the images used, and the parameters stored in the corresponding dragable sprite object 66. The corresponding on-drag and on-select handlers are similar also, except that they do not update the positions of the slider/indicators when a selection occurs.

The above then shows an innovative method using a Web browser and a server, providing the capability of selecting colors and displaying them as movable color swatches; searching for additional colors that harmonize in some arbitrary fashion with the selected color; searching for product items that approximate the color characteristics of a selected color swatch; displaying said product items as movable product sample images, saving and retrieving the color swatches and product samples and retaining their color content, relative positions and z-order; displaying product samples for those product items that are in the process of being purchased by the user; and selecting displayed product samples for purchase.

1. A color matching system comprising:
a swatch user interface for displaying at least one activatable color swatch for visually presenting a color corresponding to at least one color specification parameter specified according to a color characterization system;
at least one color control for specifying said color specification parameters; and,
a color matching module for computing a matching color based upon a color space matching parameter and color specification parameters corresponding to a color presented in an activated color swatch in said swatch user interface, said color matching module identifying a color matching said color presented in said activated color swatch.

2. The color matching system of claim 1, wherein said at least one color specification parameter is a user-selectable color space matching parameter.

3. The color matching system of claim 1, wherein each activatable color swatch in said swatch user interface is repositionable within said swatch user interface.

4. The color matching system of claim 1, wherein said color characterization system comprises a Hue-Saturation-Brightness (“HSB”) color characterization system.

5. The color matching system of claim 1, wherein said swatch user interface comprises at least one network distributable document displayable in a Web browser.

6. The color matching system of claim 1, wherein said color controls comprise a hue control, a saturation control and a brightness control.

7. The color matching system of claim 1, wherein said color space matching parameter comprises a contrast parameter.

8. The color matching system of claim 1, further comprising means for creating, saving, retrieving and deleting sets of color swatches displayable in said swatch user interface.

9. The color matching system of claim 1, further comprising a color extractor for identifying an object's color, said color extractor extracting said object color from said object, said color extractor providing said identified color to said swatch user interface for display in a color swatch.

10. The color matching system of claim 9, wherein said color extractor comprises:
an image acquisition device for acquiring a digitized image of an object;
partitioning logic for subdividing said acquired digitized image into a plurality of color zones; and,
color computing logic for computing a color for each color zone;
said color extractor displaying each computed color in a color swatch in said swatch user interface.

11. The color matching system of claim 10, wherein said color extractor further comprises:
color averaging logic for computing an average color for each color computed for each color zone;
said color extractor displaying said average color in a color swatch in said swatch user interface.

12. The color matching system of claim 10, wherein said color extractor further comprises:
a library of patterns for arranging said color zones in a selected portion of said acquired digitized image.

13. The color matching system of claim 1, further comprising:
a product database containing images of products, each said product having at least one color; and,
a product matching module for identifying products in said product database having at least one color matching said color identified by said color matching module;
said product matching module producing a selectable set of said identified products.

14. The color matching system of claim 1, further comprising shopping cart means for processing a check-out transaction for a selected product in said selectable set.

15-66. (canceled)
